(19) United States
(12) Patent Application Publication
(10) Pub. No.: US 2005/0252090 A1
(43) Pub. Date: Nov. 17, 2005

(54) Glass module, in particular a sliding window, for a vehicle, in particular a motor vehicle

(76) Inventors: Jurgen Kraus, Balve (DE); Martin Schulte, Balve (DE); Jens Vornbaumen, Altena (DE)

Correspondence Address: BANNER & WITCOFF LTD.,;ATTORNEYS FOR DURA AUTOMOTIVE, 28 STATE STREET - 28TH FLOOR, BOSTON, MA, 02109, US

(21) Appl. No.: 10/846,353

(22) Filed: May 14, 2004

(51) Int. Cl. E05F 11/52

(52) U.S. Cl. 49/415

(57) ABSTRACT

A sliding window for installation in a wall or a door of a vehicle, with a stationary window, a movable window, and guide rails that are joined to the stationary window and in which the movable window is guided. Retaining clips that can be bonded adhesively to the vehicle are arranged on the guide rails.

The invention concerns a glass module, particularly a sliding window for installation in a wall, in particular a side wall, or in a door of a vehicle, in particular a motor vehicle. The sliding window comprises a stationary part, in particulara stationary window, a movable, in particular pivoting and/or sliding window, and guide rails, in which the movable window is guided. The guide rails are joined to the stationary window, in particular adhesively bonded, or provided on the stationary window. The stationary window can be placed in an opening of the vehicle and fixed in place there, in particular by adhesive bonding. Further, the invention concerns a vehicle, particularly a motor vehicle, with a sliding window of this kind. The sliding window, particularly its stationary window and/or its movable window, can be fabricated from mineral glass, particularly safety glass, but also from plastic, it being possible for the stationary window and/or the movable window to be totally or partially transparent and/or translucent and/or opaque.

Known from EP 0 778,168 B1 is a glass module for installation in a wall of a motor vehicle, this glass module comprising a stationary window and a window that can be pivoted. The hinge for the movable window comprises a cross strip, which forms the fixed element of the lengthwise oriented hinge, the ends of which are inserted between the stationary window and the edges of the opening of the auto body. The purpose of this is to hold the pivotable window even if the stationary window breaks.

Known from EP 0 968,862 A2 is a sliding window of the kind described initially. GB 1,209,978 discloses a sliding window for installation in a motor vehicle, this sliding window having a surrounding frame made of metal, which is placed in a corresponding opening of the motor vehicle. Provided in the frame are two parallel guides for each movable window. The frame is attached to the body of the vehicle by means of retaining clips.

The object of the invention is to propose an improved sliding window of the kind presented initially.

This object is solved in accordance with the invention by way of the features of claim 1. Arranged on the guide rails are retaining clips for connection with the vehicle, in particular with the vehicle body or with the vehicle doors. The retaining clips can be bonded adhesively to the vehicle. When the stationary window can be bonded adhesively to the vehicle or to the vehicle body or to the vehicle doors, the same adhesive bonding or adhesive bead as that used for the adhesive bond between the retaining clips and the vehicle can be used. However, it is also possible to use a separate adhesive bonding or adhesive bead for the adhesive bond between the retaining clips and the vehicle.

The number and arrangement of the retaining clips can be determined according to the respective requirements. By means of the retaining clips, it is ensured that the guide rails remain joined to the vehicle even in the case of damage or breakage of the stationary window, so that, in these cases, dangers due to the movable window are prevented. Continuous structural parts, that is, structural parts that engage over the entire length or width of the stationary part or of the stationary window, are not necessary. Practical tests have shown that the requisite safety can nonetheless be achieved. The invention affords the additional advantage that the structural parts that ensure this safety are also not visible from the vehicle interior.

Advantageous enhancements are described in the subclaims.

It is advantageous when the retaining clips have an extended part that projects into the region between the stationary window and a part of the vehicle, particularly of the vehicle body or the vehicle doors.

The retaining clips can be joined to the guide rails in a detachable manner or in a fixed manner.

According to an advantageous enhancement, the retaining clips are inserted onto the guide rails. It is advantageous when the guide rails have ribs and the retaining clips are plugged onto these ribs.

Another advantageous enhancement is characterized in that that the retaining clips are mounted so that they can rotate on the guide rails. The axis of rotation can, in particular, run perpendicular or parallel to the lengthwise direction of the guide rails. It is advantageous when the retaining clips have a pivot pin or a pivot anchor.

According to another advantageous enhancement, the retaining clips are riveted to the guide rails. Preferably, a sheet metal insert, on which the rivet connection is provided, is present on or in the guide rails, which can be fabricated from plastic or can have component parts that are made of plastic.

According to another advantageous enhancement, the retaining clips are bonded adhesively to the guide rails. When the guide rail is bonded adhesively to the stationary window, this adhesive bonding or adhesive bead can be used also for the adhesive bonding of the retaining clips to the guide rail.

The retaining clips can be constructed as foil, particularly as sheet metal foil. This is particularly advantageous in the case when the same adhesive bonding or adhesive bead is used for the connection between the retaining clips and the guide rail, on the one hand, and between the stationary window and the guide rail, on the other.

According to another advantageous enhancement, the retaining clips can be clamped to the vehicle. The clamping can occur, in particular, by means of retaining clips that can rotate, particularly pivot pins or pivot anchors.

Another advantageous enhancement is characterized in that the retaining clips have a clinch flange for a vehicle part.

The invention further concerns a vehicle, particularly a motor vehicle, which is characterized by a sliding window in accordance with the invention, wherein the retaining clips are bonded adhesively to the vehicle or to the vehicle body or to the vehicle doors. According to an advantageous enhancement, the retaining clips are clamped to the vehicle or to the vehicle body or to the vehicle doors and/or are joined by means of a clinch flange.

Examples of embodiment of the invention will be described in detail below on the basis of the attached drawing. The following is shown in the drawing:

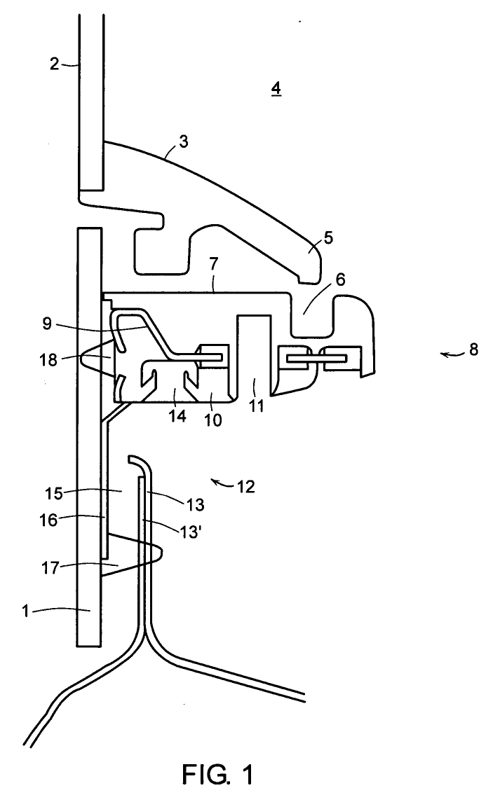

FIG. 1 a first embodiment with a retaining clip, in a cross section, plugged onto the functional element constructed as a guide rail,

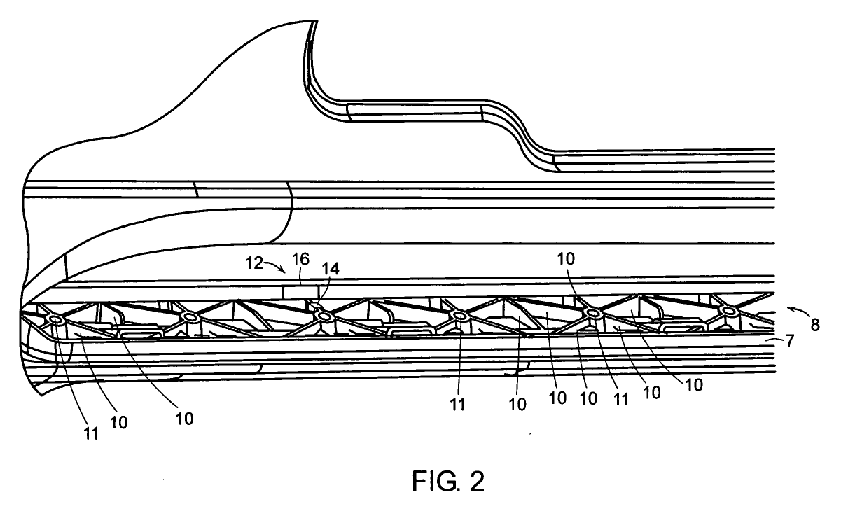

FIG. 2 the embodiment according to FIG. 1 in a perspective view from above,

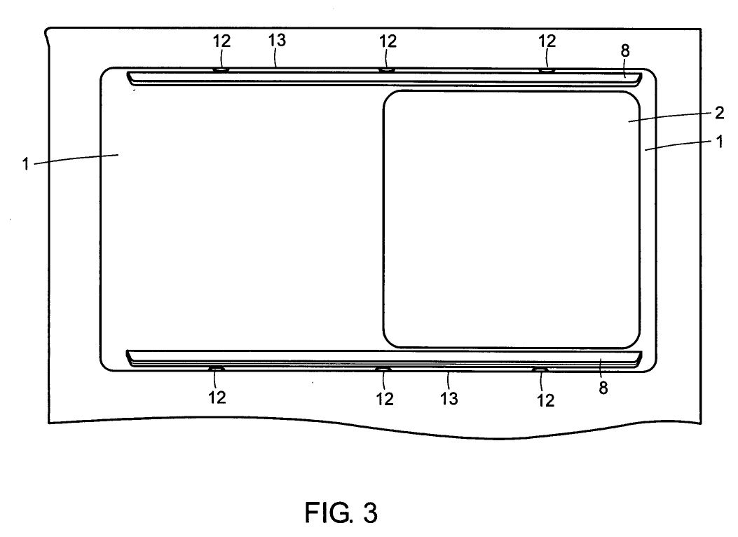

FIG. 3 the embodiment according to FIGS. 1 and 2 in a side view.

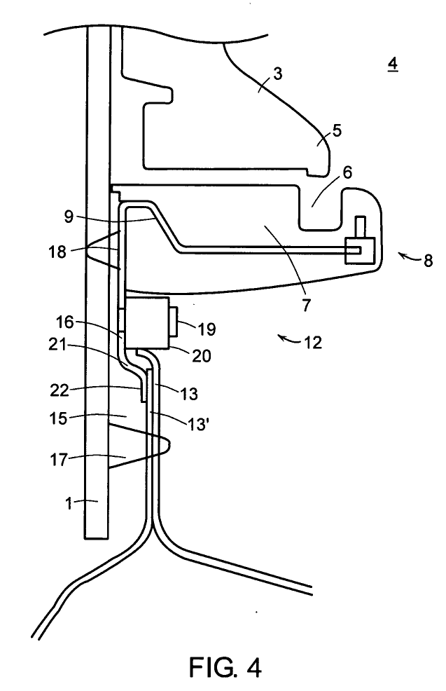

FIG. 4 a second embodiment with a retaining clip that has a pivot pin, in a cross section in the state prior to clamping,

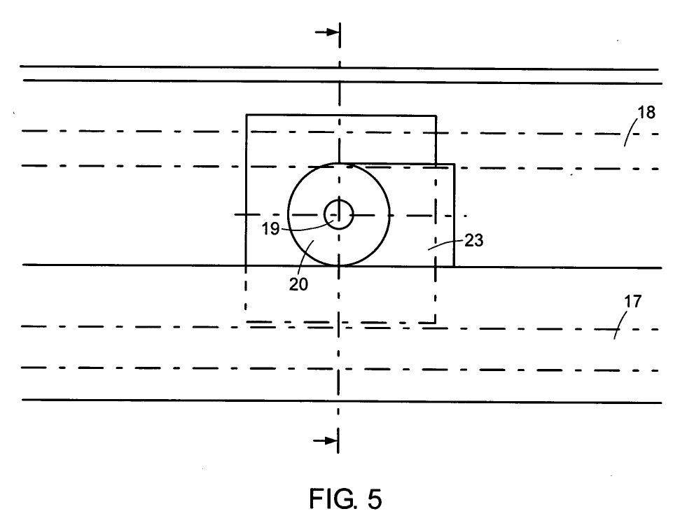

FIG. 5 the embodiment according to FIG. 4 in a side view,

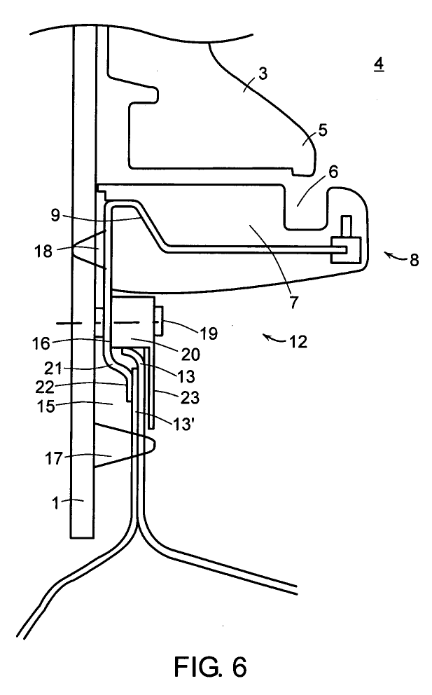

FIG. 6 the embodiment according to FIGS. 4 and 5 in the clamped state in a cross section,

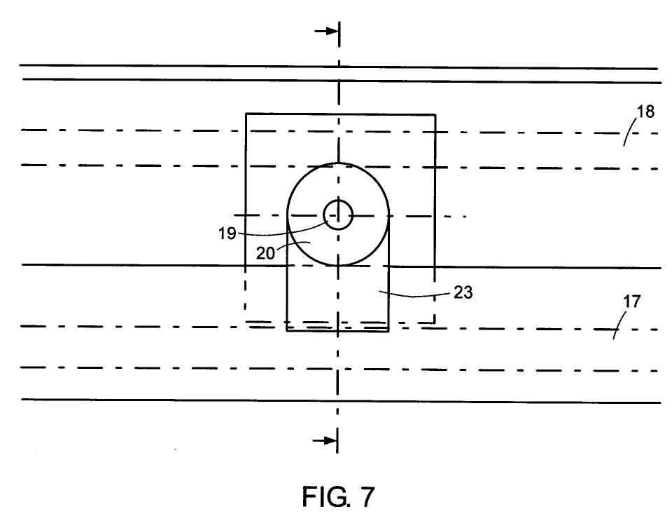

FIG. 7 the embodiment according to FIG. 6 in a side view,

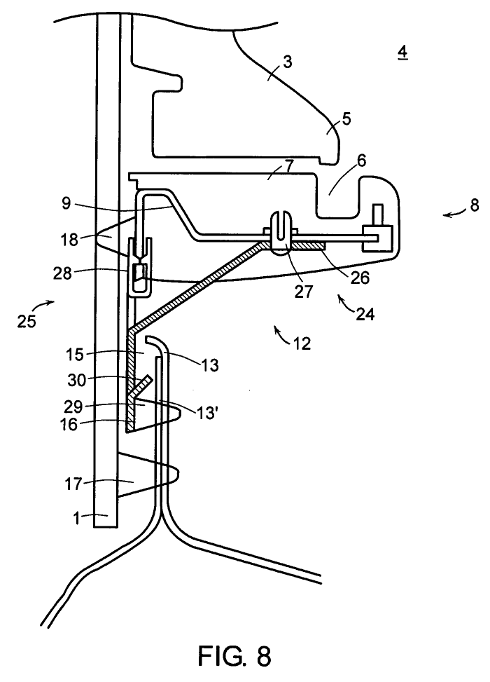

FIG. 8 a third embodiment with a retaining clip that is riveted to the guide rail and bonded adhesively to the vehicle body, in a cross section,

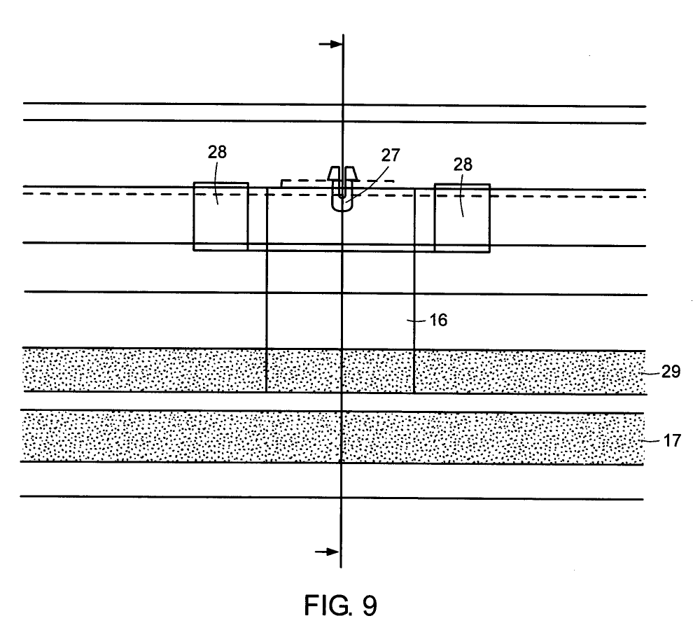

FIG. 9 the embodiment according to FIG. 8 in a side view,

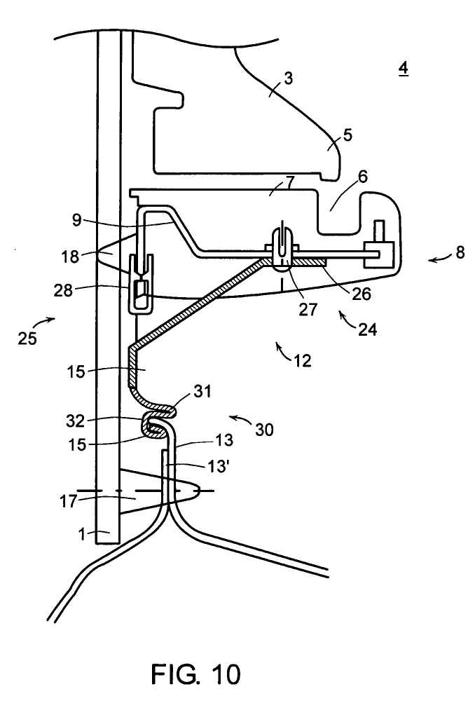

FIG. 10 a fourth embodiment with a retaining clip that is riveted to the guide rail and joined to the vehicle body by means of a clinch flange, in a cross section,

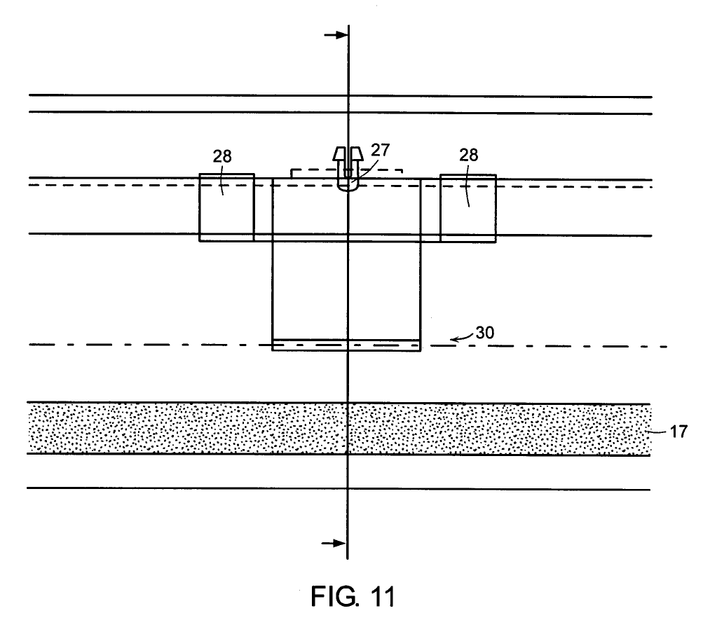

FIG. 11 the embodiment according to FIG. 10 in a side view,

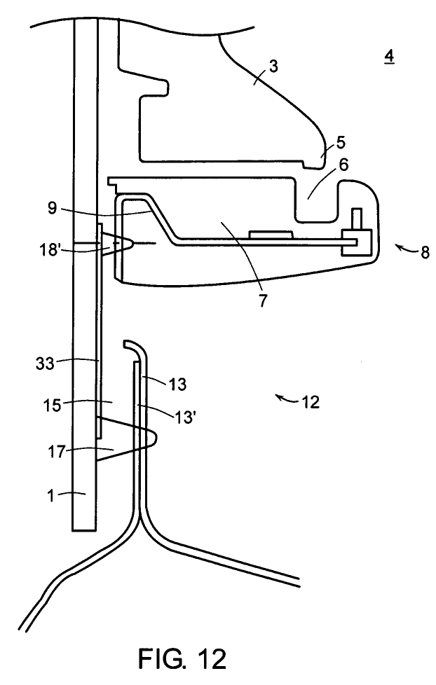

FIG. 12 a fifth embodiment with a retaining clip that is constructed as sheet metal foil and is bonded adhesively to the guide rail and the vehicle body, in a cross section,

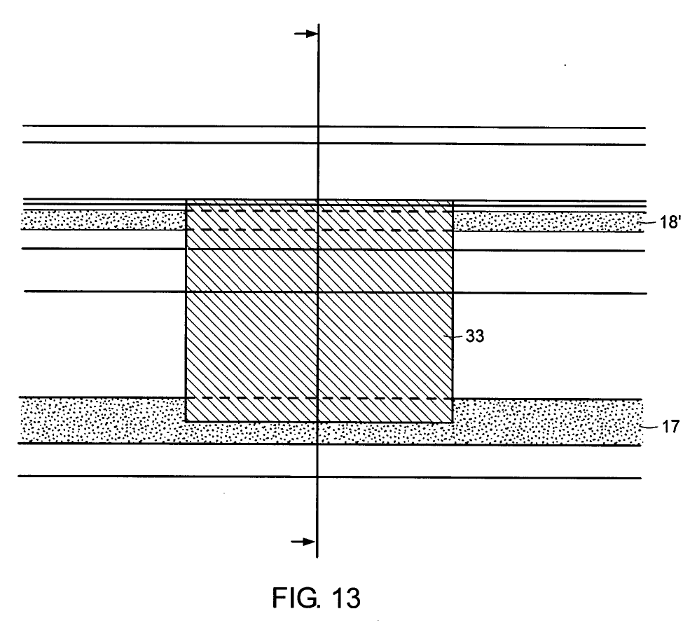

FIG. 13 the embodiment according to FIG. 12 in a side view,

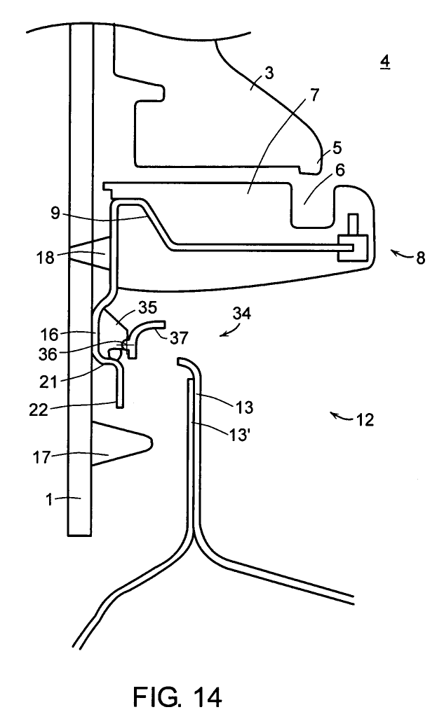

FIG. 14 a sixth embodiment with a retaining clip that has a pivot anchor, in a cross section, in the state prior to the clamping,

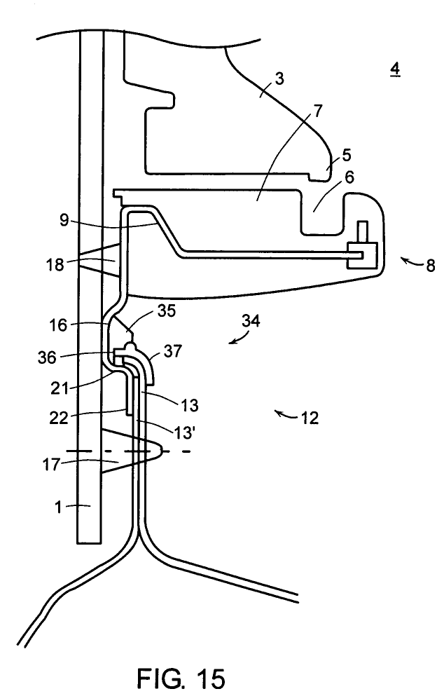

FIG. 15 the retaining clip according to FIG. 14 after the clamping, and

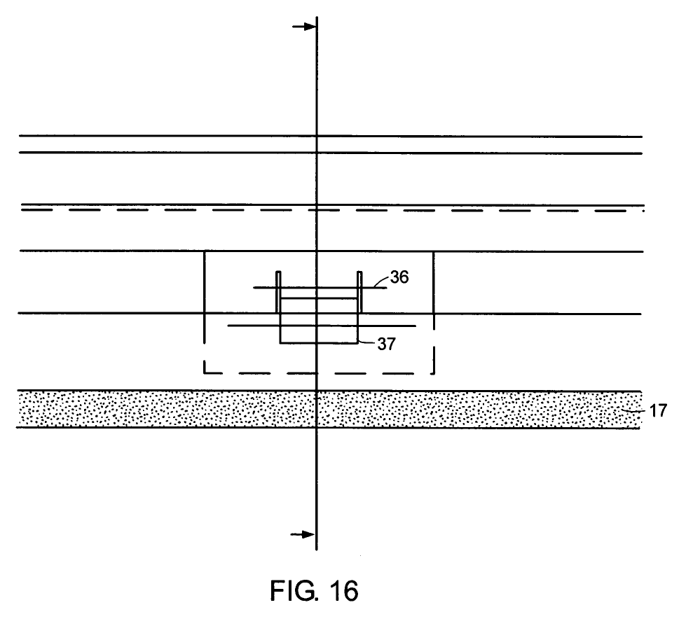

FIG. 16 the retaining clip according to FIGS. 14 and 15 in a side view.

FIGS. 1 to 3 show a first embodiment of a sliding window for installation in a side wall of a motor vehicle, with a stationary window 1 and a sliding window 2, which includes a frame 3, which has an extended portion 5 that is directed toward the interior 4 of the motor vehicle and which is provided at the inner and bottom end with a guide bolt (not shown in the drawing), which engages in a corresponding guide groove 6 in the outer shell 7 of a guide rail 8 and is guided there. The guide rail 8 comprises, further, a sheet metal insert 9. The outer shell 7 has vertical ribs 10 on its bottom side, which are directed outward from central cores 11 in a starlike manner, and additional ribs 10 that lie between two adjacent cavities 11.

The sliding window 2 is moved longitudinally by way of the guide bolts sliding in the guide groove 6 and, particularly in the end regions, is guided so as to move laterally and/or so as to pivot, as described, for example, in EP 0 968,862 A2 or in EP 0 683,064 A1.

Arranged on the guide rail 8 is a retaining clip 12, which makes a connection between the guide rail 8 and the sheet metal pieces 13, 13′ of the vehicle body, which project vertically upward. The retaining clip 12 has tabs 14, with which it is plugged onto a rib 10 of the guide rail 8. The tabs 14 enclose the rib 10. After being plugged in, they are clamped to the rib 10.

The retaining clip 12 further comprises an extended part 16, which projects into the region 15 between the stationary window 1 and the sheet metal pieces 13, 13′ of the vehicle body and is bonded adhesively to the sheet metal pieces 13, 13′, namely through the adhesive bead 17, by means of which the stationary window 1 is also bonded adhesively to these sheet metal pieces 13, 13′. As can be seen from FIG. 1, the bottom end region of the extended part 16 is overlapped by somewhat more than half of the adhesive bead 17. The outer shell 7 of the guide rail 8 is bonded adhesively by another adhesive bead 18 to the stationary window 1.

The upward directed sheet metal pieces 13, 13′ form a structural flange, which delimits an opening in the vehicle, into which the stationary window 1 is inserted and bonded adhesively in place. In the case of breakage of the stationary window 1, the retaining clips 12 and, with them, the guide rails 8 remain joined to the sheet metal pieces 13, 13′ of the vehicle body, so that the slideable window 2 can retain its position held in the guide grooves 6, this making it possible to prevent dangers due to sliding windows 2 that have become loose.

It can be seen from FIG. 3 that the stationary window 1 completely surrounds the slideable window 2 and that the stationary window 1 is placed in a corresponding opening in the vehicle body, which is rimmed by the sheet metal pieces 13, 13′.

Shown in FIGS. 4 to 7 is a second embodiment of a sliding window, in which corresponding parts are provided with the same reference numbers. In this embodiment, a bearing bolt 19 is inserted in the essentially vertical extended part 16 directed downward from the guide rail 8 and on its essentially horizontally running axis is rotatably mounted a pivot pin 20, which extends with its bottom end to the top end of the inner sheet metal piece 13. The top end of the inner sheet metal piece 13 is bent outwards at an angle of about 90°.

The bottom end region of the extended part 16 is provided with an inward directed right-angle bend 21, the bottom end region 22 of which lies against the top end region of the outer sheet metal piece 13′.

The pivot pin 20 has an outward projecting clamping part 23, which, by a rotation by 90°, can be brought out of the initial position, shown in FIGS. 4, 5, into the clamped position, shown in FIGS. 6 and 7, in which the sheet metal pieces 13, 13′ are enclosed and clamped by the bottom end region 22 and the clamping part 23. The retaining clip 12 is joined to the vehicle body by means of this clamp connection.

In the embodiment according to FIGS. 4 to 7, the retaining clip 12 is formed by the sheet metal insert 9, the top region of which is enclosed by the outer shell 7 and the bottom region of which forms the extended part 16, the right-angle bend 21, and the bottom end region 22.

Represented in FIGS. 8 and 9 is a third embodiment, in which the retaining clip 12 is joined to the guide rail 8 by means of a rivet connection 24 and a pin connection 25. The retaining clip 12 has an inner, top end region 26, which lies on a corresponding horizontal region of the sheet metal insert 9 in the outer shell 7 of the guide rail 8. A rivet 27 penetrates the inner, top end region 26 of the retaining clip 12 and the horizontal region of the sheet metal insert, joining these two parts to each other.

The retaining clip 12 further comprises two U-shaped ends 28, which are directed vertically upward and which receive between them a vertical, downward directed end region of the sheet metal insert 9, which is clamped within the U-shaped ends 28 by mutually overlapping projections.

The downward directed extended part 16 of the retaining clip 12, which lies in the region 15 between the stationary window 1 and the sheet metal pieces 13, 13′, is bonded adhesively there to the sheet metal pieces 13, 13′ by means of an additional adhesive bead 29, which differs from the adhesive bead 17 between the stationary window 1 and the sheet metal pieces 13, 13′ (the same adhesive bead 17 could also be used). Further, provided in the bottom region of the extended part 16 are upward and inward directed bends 30, which grasp from behind, in the manner of a barb, the outward bent, top end region of the inner sheet metal piece 13.

The fourth embodiment, represented in FIGS. 10 and 11, involves a modification of the third embodiment according to FIGS. 8 and 9, in which the retaining clip 12 is joined by means of a clinch flange 30 to the vehicle body, namely, to the top, outward bent end of the inner sheet metal piece 13. The clinch flange 30 consists of two forked ends 31, 32, which each are bent inward by 180° and enclose the top end of the sheet metal piece 13, which, in this way, is clutched.

In the fifth embodiment, which is shown in FIGS. 12 and 13, the retaining clip 12 is formed by a sheet metal foil 33, the top end region of which is bonded adhesively by means of an adhesive bead 18′ to the sheet metal insert 9 in the outer shell 7 of the guide rail 8 and, at the same time, to the stationary window 1 and the bottom end region of which is bonded adhesively by means of the adhesive bead 17 to the outer sheet metal piece 13′ of the vehicle body and, at the same time, to the stationary window 1, the bottom end of the sheet metal foil 33 reaching to about the middle of the adhesive bead 17.

In the sixth embodiment, shown in FIGS. 14 to 16, the retaining clip 12 is joined to the guide rail 8 by means of a pivot anchor 34. Similarly to the second embodiment according to FIGS. 4 to 7, the retaining clip 12 is formed by the sheet metal insert 9 and the downward directed extended part 16 has an inward directed right-angle bend 21, the bottom end region 22 of which can lie on the top, vertical end region of the outer sheet metal piece 13′. Above the right-angle bend 21, the extended part 16 has an inward directed flange 35, on the inner end region of which is provided an essentially horizontal axis of rotation 36, which runs parallel to the longitudinal extended part of the guide rail 8, for an anchoring part 37, which has essentially a quarter circle-shaped cross section. In the initial position, shown in FIG. 14, the quarter circle is opened inward and downward, so that the mounting can occur through an approach at the top end of the sheet metal pieces 13, 13′. In the final position shown in FIG. 15, the anchoring part 37 has been pivoted by 90° in the clockwise direction, so that the inner flange of its quarter circle lies on the corresponding outer top end surface of the inner sheet metal piece 13. In this position, the top ends of the sheet metal pieces 13, 13′ are enclosed and clamped by the bottom end region 22 and the anchoring part 37. Below this, the stationary window 1 is bonded adhesively to the sheet metal pieces 13, 13′ by means of the adhesive bead 17.

1. A sliding window for installation in a wall or a door of a vehicle, with a stationary window, with a movable window, and with guide rails, which are joined to the stationary window and in which the movable window is guided, characterized in that retaining clips, which can be bonded adhesively to the vehicle are arranged on the guide rails.

2. The sliding window according to claim 1, further characterized in that the guide rails are bonded adhesively to the stationary window.

3. The sliding window according to claim 1, further characterized in that the retaining clips have an extended part projecting into the region between the stationary window and a part of the vehicle.

4. The sliding window according to claim 1, further characterized in that the retaining clips are plugged onto the guide rails.

5. The sliding window according to claim 1, further characterized in that the retaining clips are mounted so that they can pivot on the guide rail.

6. The sliding window according to claim 5, further characterized in that the retaining clips have a pivot pin.

7. The sliding window according to claim 5, further characterized in that the retaining clips have a pivot anchor.

8. The sliding window according to claim 1, further characterized in that the retaining clips are riveted to the guide rail.

9. The sliding window according to claim 1, further characterized in that the retaining clips are bonded adhesively to the guide rail.

10. The sliding window according to claim 1, further characterized in that the retaining clips are constructed as sheet metal foil.

11. The sliding window according to claim 1, further characterized in that the retaining clips can be clamped to the vehicle.

12. The sliding window according to claim 1, further characterized in that the retaining clips have a clinch flange for a vehicle part.

13. A vehicle, in particular a motor vehicle, characterized by a sliding window according to claim 1, wherein the retaining clips are bonded adhesively to the vehicle.

14. The vehicle, in particular the motor vehicle, according to claim 13, further characterized in that the retaining clips are clamped to the vehicle and/or are joined by means of a clinch flange.
